(19) United States
(12) Patent Application Publication
(10) Pub. No.: US 2009/0141760 A1
(43) Pub. Date: Jun. 4, 2009

(54) DRIVE CONTROL APPARATUS AND DRIVE CONTROL METHOD OF SEMICONDUCTOR LASER

(75) Inventors: Masahiro Saito, Yokohama-shi (JP); Takashi Usui, Yokohama-shi (JP); Kazuo Watabe, Yokohama-shi (JP); Keiichiro Yusu, Yokohama-shi (JP); Chosaku Noda, Yokohama-shi (JP); Nobuaki Kaji, Yokohama-shi (JP); Kazuto Kuroda, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/260,824

(22) Filed: Oct. 29, 2008

(30) Foreign Application Priority Data
Oct. 31, 2007 (JP) 2007-283844

(51) Int. Cl. H01S 3/00

(52) U.S. Cl. 372/38.02

(57) ABSTRACT

According to one embodiment, a drive control apparatus of a semiconductor laser includes a driving circuit which drives the semiconductor laser by applying pulses transiting from bias current to peak current to the semiconductor laser as laser driving current that causes relaxation oscillation of emission light intensity of the semiconductor laser, and a control circuit which controls the bias current such that the bias current has a predetermined ratio limiting fluctuation of a leading peak value of the relaxation oscillation occurring for each application of pulses relative to threshold current of the semiconductor laser. The control circuit changes the bias current to maintain the predetermined ratio relative to fluctuation of the threshold current.

### CROSS-REFERENCE TO RELATED APPLICATIONS

This application is based upon and claims the benefit of priority from Japanese Patent Application No. 2007-283844, filed Oct. 31, 2007, the entire contents of which are incorporated herein by reference.

### BACKGROUND

1. Field

One embodiment of the present invention relates to a drive control apparatus and a drive control method of a semiconductor laser that control a driving current of a semiconductor laser which conducts recording utilizing relaxation oscillation.

2. Description of the Related Art

Digital versatile disks (DVDs) have been widely used around the world as optical disks, and are distributed as products mainly containing digital content such as movies. An optical disk such as HDDVD having a larger capacity than the capacity of the existing DVD has been realized. Such an optical disk is strongly requested to have a high transfer rate in addition to a demand for a large capacity. For example, regarding HDDVD-R or HDDVD-RW, the 2× speed standard has already been put into force, based on a 1× speed standardized as a linear speed of 6.61 m/s. Higher speeds, such as 4× speed or 8× speed, are expected to be desired in the future.

Data recording to an optical disk is performed by applying pulses whose peak currents are generally maintained for a fixed time as the laser driving current to a semiconductor laser which is a laser light source to drive the semiconductor laser, thereby forming, on an optical disk, a mark sequence having a length corresponding to data by laser light with an emission light intensity for recording (namely, recording power) emitted from the semiconductor laser. Application of the laser driving current raises the emission light intensity of the semiconductor laser up to the recording power. Just after rising of the laser driving current, an actual emission light intensity reaches a recording power through relaxation oscillation in which it repeatedly increases and decreases with respect to the recording power. Since the relaxation oscillation causes a delay of transition to the recording power, control for suppressing the relaxation oscillation as much as possible is commonly conducted in generation of the laser driving current.

Recently, positive utilization of emission light obtained by relaxation oscillation has been examined for optical disk recording apparatuses which record data on optical disks. A technique of shaping emission light obtained by relaxation oscillation to a short optical pulse with large intensity amplitude and reduced skirt shape has been proposed (for example, see JP-A-2006-278926). In a drive control apparatus of a semiconductor laser disclosed in JP-A-2006-278926, the laser driving current (namely, threshold current) at the point the emission light intensity starts to increase rapidly is utilized as a reference value for a direct-current bias component, and the current bias component is set to a value different from the reference value by a predetermined value. Here, the current bias component is optimized based upon a pulse frequency of the laser driving current.

However, even if a pulse width of the laser driving current in a periodic drive of the semiconductor laser is kept constant, such a problem arises that a relaxation oscillation waveform (especially, a leading peak value) of emission light intensity occurring for each pulse application fluctuates easily, which results in difficulty in recording data stably. Further, the fluctuation largely depends on the fluctuation of threshold current due to the temperature of the semiconductor laser. Such a problem is not considered in optimization performed in the drive control apparatus of a semiconductor laser disclosed in JP-A-2006-278926. Therefore, a thermoelectric cooler (TEC), such as a Peltier element, is provided to prevent temperature change of a semiconductor laser. Therefore, the temperature of the semiconductor laser is detected by a thermistor and a cooling temperature of the TEC is adjusted to a target value based upon temperature data obtained by the thermistor. Accordingly, it is unnecessary to consider fluctuation of the threshold current of the semiconductor laser in the abovementioned optimization.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram schematically showing a configuration example of an optical recording apparatus according to an embodiment of the present invention;

FIG. 2 is an exemplary diagram showing a sectional structure of an optical disk shown in FIG. 1;

FIG. 3 is an exemplary diagram showing a light emitting body structure of a semiconductor laser shown in FIG. 1;

FIG. 4A is an exemplary diagram showing a waveform of the laser driving current applied in a conventional recording system obtaining emission light of a semiconductor laser shown in FIG. 1 as an ordinary recording pulse;

FIG. 4B is an exemplary diagram showing an intensity waveform of emission light of the semiconductor laser obtained by application of the laser driving current shown in FIG. 4A;

FIG. 4C is an exemplary diagram showing a waveform of the laser driving current applied in a recording system of the embodiment obtaining emission light of the semiconductor laser shown in FIG. 1 as a short optical pulse utilizing relaxation oscillation;

FIG. 4D is an exemplary diagram showing an intensity waveform of emission light of the semiconductor laser obtained by application of the laser driving current shown in FIG. 4C;

FIG. 5 is an exemplary diagram showing the measurement result of relaxation oscillation waveform of emission light intensity obtained when a laser resonator length of the semiconductor laser shown in FIG. 1 is 650 μm;

FIG. 6A is an exemplary diagram for explaining an amorphous mark formed by an ordinary recording pulse shown in FIG. 4B;

FIG. 6B is an exemplary diagram for explaining an amorphous mark formed by short optical recording pulse shown in FIG. 4D;

FIG. 7A is an exemplary diagram for explaining a temperature distribution on a recording track in case of recording conducted by the short optical recording pulse shown in FIG. 4D;

FIG. 7B is an exemplary diagram for explaining a temperature distribution on a recording track in the case of recording conducted by the ordinary recording pulse shown in FIG. 4B;

FIG. 8 is an exemplary diagram showing a relaxation oscillation waveform of emission light intensity obtained when the laser driving current to the semiconductor laser shown in FIG. 1 is controlled so as to generate a relaxation oscillation pulse three times;

FIG. 9 is an exemplary diagram showing a semiconductor laser drive control structure of the optical recording apparatus shown in FIG. 1 in more detail;

FIG. 10 is an exemplary diagram showing a relationship between the laser driving current applied to the semiconductor laser shown in FIG. 9 and emission light intensity;

FIG. 11 is an exemplary diagram showing a relationship between bias current applied to the semiconductor laser shown in FIG. 9 as the laser driving current and fluctuation of a leading peak value of emission light intensity obtained by relaxation oscillation;

FIG. 12 is an exemplary diagram showing a waveform of the laser driving current applied to the semiconductor laser shown in FIG. 9;

FIG. 13 is an exemplary diagram showing a processing for obtaining threshold current of the semiconductor laser shown in FIG. 9;

FIG. 14 is an exemplary diagram showing a processing obtaining a relationship between temperature and threshold current of the semiconductor laser shown in FIG. 9;

FIG. 15 is an exemplary diagram showing characteristics of the laser driving current of the semiconductor laser shown in FIG. 9 for emission light intensity current at three temperatures;

FIG. 16 is an exemplary diagram showing a relationship between temperature and threshold current of the semiconductor laser shown in FIG. 9;

FIG. 17 is an exemplary diagram for explaining a relationship among the laser driving current supplied to the semiconductor laser shown in FIG. 1, a waveform of emission light intensity, and a record mark formed on a recording film on an optical disk; and

FIG. 18 is an exemplary diagram for explaining a relationship between a waveform of emission light intensity shown in FIG. 17 and a period of time T1.

### DETAILED DESCRIPTION

Various embodiments according to the invention will be described hereinafter with reference to the accompanying drawings.

According to one embodiment of the present invention, there is provided a drive control apparatus of a semiconductor laser which comprises a driving circuit which drives the semiconductor laser by applying pulses transiting from a bias current to a peak current to the semiconductor laser as a laser driving current that causes relaxation oscillation of emission light intensity of the semiconductor laser; and a control circuit which controls the bias current such that the bias current has a predetermined ratio limiting fluctuation of a leading peak value of the relaxation oscillation occurring for each application of pulses relative to a threshold current of the semiconductor laser, the control circuit being configured to change the bias current to maintain the predetermined ratio relative to fluctuation of the threshold current.

According to one embodiment of the present invention, there is provided a drive control method of a semiconductor laser, which comprises: driving the semiconductor laser by applying pulses transiting from bias current to peak current to the semiconductor laser as the laser driving current that causes relaxation oscillation of emission light intensity of the semiconductor laser; and controlling the bias current such that the bias current has a predetermined ratio limiting fluctuation of a leading peak value of relaxation oscillation occurring for each pulse application relative to a threshold current of the semiconductor laser, the bias current being changed to maintain the predetermined ratio relative to fluctuation of the threshold current.

The present inventors have found that, when a semiconductor laser is driven by applying pulses transiting from bias current to peak current to the semiconductor laser as the laser driving current causing relaxation oscillation of emission light intensity of the semiconductor laser, fluctuation of a leading peak value of relaxation oscillation occurring for each pulse application depends on the bias current and the fluctuation of the leading peak value can be limited by the ratio of the bias current to the threshold current of the semiconductor laser.

Therefore, such control is conducted that the bias current has the predetermined ratio limiting fluctuation of a leading peak value relative to the threshold current of the semiconductor laser. When the threshold current of the semiconductor laser fluctuates depending on the temperature of the semiconductor laser in the control, reliable limitation of the fluctuation of the leading peak value becomes impossible, so that the bias current is changed to maintain the predetermined ratio relative to fluctuation of the threshold current. Accordingly, even if the threshold current fluctuates, a relaxation oscillation waveform of emission light intensity can be stabilized. When the abovementioned control is performed, it is unnecessary to prevent temperature change of the semiconductor laser, so that a thermoelectric cooler (TEC) such as Peltier element can be omitted.

An optical recording apparatus according to an embodiment of the present invention will be explained below.

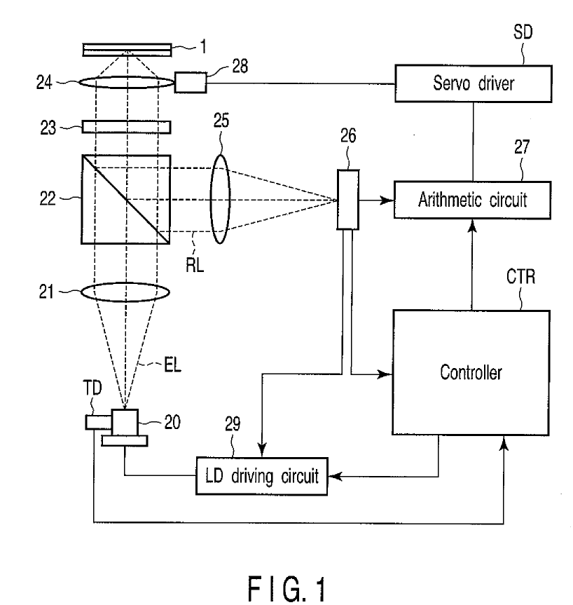

FIG. 1 schematically shows a configuration example of the optical recording apparatus. In the optical recording apparatus, a semiconductor laser 20 such as a laser diode is used as a laser light source with a short wavelength. A wavelength of emission light falls within a purple wavelength band in a range of 400 nm to 410 nm, for example.

Emission light EL from the semiconductor laser 20 is collimated to collimated light by a collimating lens 21 then passed through a polarization beam splitter 22 and a λ/4 plate 23, and then enters an objective lens 24. Thereafter, light from the objective lens 24 goes through a substrate of an optical disk 1 to be focused on a target information recording layer. After reflected light RL from the information recording layer of the optical disk 1 goes through a cover layer 4 of the optical disk 1 again to go through the objective lens 24 and the λ/4 plate 23 and is reflected by the polarization beam splitter 22, it goes through a condenser lens 25 to enter a light detector 26.

A light receiving unit of the light detector 26 is generally divided to a plurality of light receiving sections and currents corresponding to light intensities are output from respective light receiving sections. After the current output is converted to a voltage by an I/V amplifier (not shown), it is processed in an arithmetic manner into an HF signal reproducing user data information, a focus error signal for controlling a beam spot position based upon a light source on the optical disk 1, a track error signal, and the like by an arithmetic circuit 27. The arithmetic circuit 27 is controlled by a controller CTR.

The objective lens 24 can be driven in upper and lower directions and in a disk radial direction by an actuator 28, and is controlled by a servo driver SD so as to follow an information track on the optical disk 1. The optical disk 1 is a recording type disk on which information can be written, and it is recorded with information by emission light EL from the semiconductor laser 20. A light amount (light intensity) of the emission light EL from the semiconductor laser 20 can be controlled by a semiconductor laser driving circuit (LD driving circuit) 29 and emission light EL of the semiconductor laser 20 is emitted to the optical disk 1 as relaxation oscillation pulses at the time of information recording. The LD driving circuit 29 is controlled by the controller CTR. The recording pulse emitted to the optical disk 1 at the time of information recording will be described in detail later.

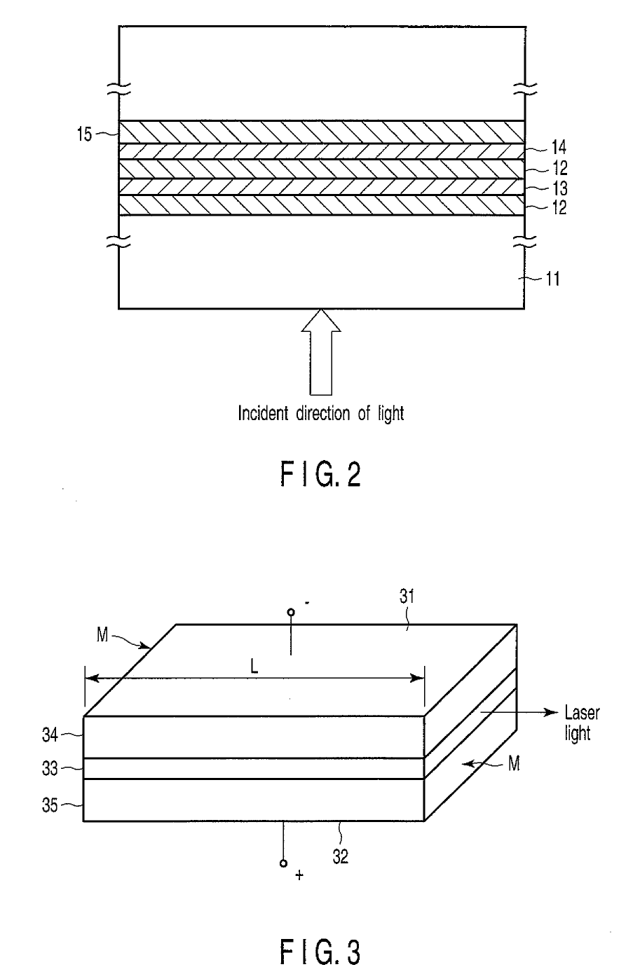

FIG. 2 shows an example of a sectional structure of the optical disk 1 used in the optical recording apparatus. A recording layer 13 comprising, for example, a phase-change recording film is formed on a substrate 11 made from polycarbonate via a protective layer 12 made from a dielectric. Another protective layer 12 made from dielectric is formed on the recording layer 13, and a conductive reflecting layer 14 is formed on the protective layer 12. Further, another substrate 11 made from polycarbonate is formed on the reflecting layer 14 so as to sandwich an adhesive layer 15.

The overall structure of optical disk 1 comprises two disks formed with an information recording layer comprising a recording film on at least one substrate bonded to each other so as to face opposite directions. A thickness of one substrate is, for example, about 0.6 mm, and the total thickness of the optical disk 1 is about 1.2 mm.

Incidentally, in the embodiment, an example of the optical disk including four information recording layers has been shown, but the present invention can be applied to an optical disk having five or more information recording layers and configured such that interface layers are provided above and below the recording layer 13. In the embodiment, a case where one information recording layer is provided has been shown, but the present invention can be applied to an optical disk having two or more information recording layers. Further, in the embodiment, a disk-like optical disk is used as the recording medium, but the present invention can be applied to a card-shaped recording medium.

FIG. 3 shows one example of a light emitting structure of the semiconductor laser 20. In FIG. 3, only a semiconductor chip section serving as a light emitting body of the semiconductor laser 20 is shown, but the chip section is ordinarily fixed to a metal block serving as a heat sink and is configured to include a base member, a cap with a glass window, and the like.

Here, explanation is made using only the semiconductor chip section directly related to laser emission. A semiconductor laser chip is a micro block having a thickness (up-and-down direction on plane in FIG. 3) of 0.15 mm, a length (L in FIG. 3) of 0.5 mm, and a width (depth direction in FIG. 3) of about 0.2 mm, as one example. An upper end 31 and a lower end 32 of the laser chip configure electrodes, respectively, and the upper end 31 forms a − (minus) electrode, and the lower end 32 forms a + (plus) electrode.

A layer emitting laser light is a central active layer 33, and an upper clad layer 34 and a lower clad layer 35 are formed so as to sandwich the central active layer 33 above and below. The upper clad layer 34 is an n-type clad layer containing many electrons and the lower clad layer 35 is a p-type clad layer containing many holes. A forward voltage is applied from the electrode 32 to the electrode 31 between the electrode 32 and the electrode 31. Thereby, when current flows from the electrode 32 toward the electrode 31, many holes and electrons excited within the active layer 33 are recombined, so that light corresponding to energy lost at the joining time is emitted. Material selection is performed such that the refractive indexes of the upper clad layer 34 and the lower clad layer 35 are lower than the refractive index of the active layer 33 (5% or less, as one example), so that light generated in the active layer 33 configures a light wave advancing within the active layer 33 in left and right directions while being reflected by interfaces between the active layer 33 and the upper and lower clad layers 34 and 35.

Left and right end faces of the active layer 33 in FIG. 3 form mirror faces M and the active layer 33 itself forms a light resonator. The light wave advancing within the active layer 33 in left and right directions and reflected by the mirror faces at the left and right both ends is amplified within the active layer 33 and it is finally emitted from a right end (and a left end) in FIG. 3 as laser light. At this time, a resonator length of the semiconductor laser 20 is a length L in a left-and-right direction.

The semiconductor laser 20 is controlled by the laser driving current generated by the LD driving circuit 29. Emission light from the semiconductor laser 20 is generated by the laser driving current from the LD driving circuit 29 as recording pulses used for recording on the optical disk 1.

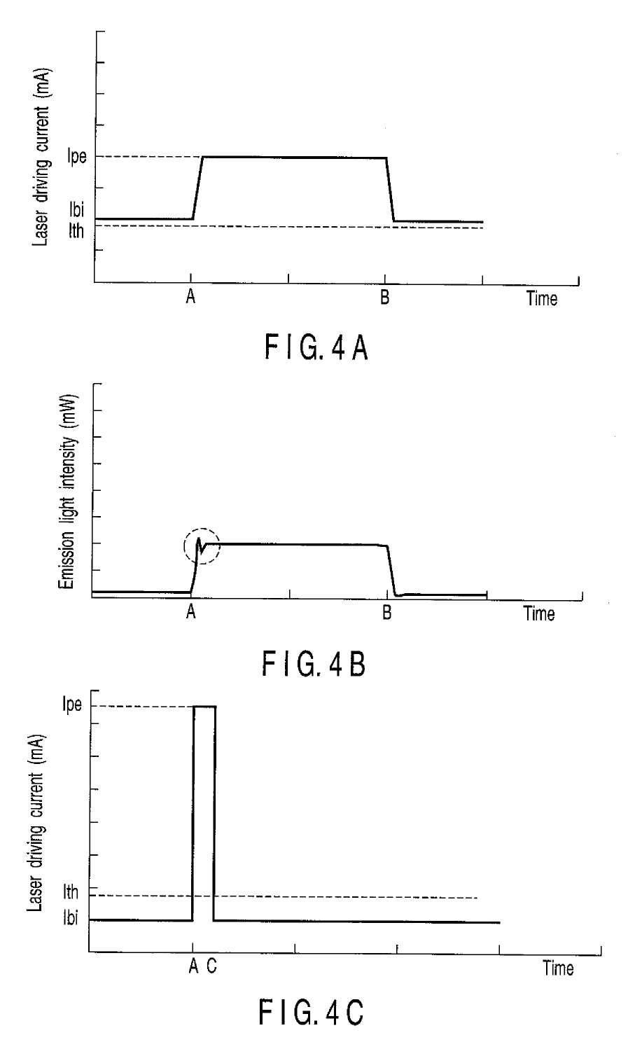

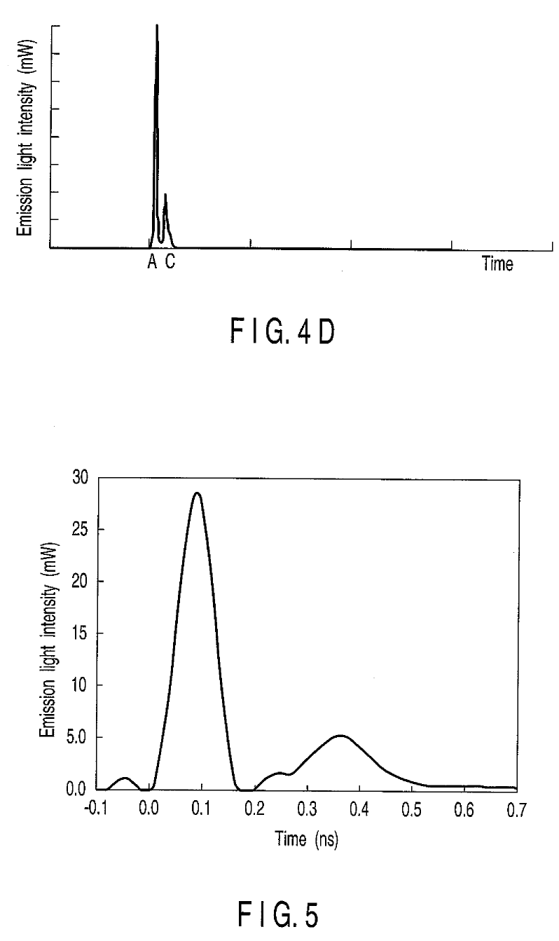

FIG. 4A shows a waveform of the laser driving current applied in a conventional recording system obtaining emission light of the semiconductor laser 20 as ordinary recording pulses, and FIG. 4B shows an intensity waveform of emission light of the semiconductor laser 20 obtained by application of the laser driving current shown in FIG. 4A. FIG. 4C shows a waveform of the laser driving current applied in a recording system of the embodiment obtaining emission light of the semiconductor laser 20 as a short optical recording pulse utilizing relaxation oscillation, and FIG. 4D shows an intensity waveform of emission light of the semiconductor laser 20 obtained by application of the laser driving current shown in FIG. 4C.

The laser driving current is controlled as pulses transiting between two levels of bias current Ibi and peak current Ipe shown in FIGS. 4A and 4C. Incidentally, the bias current Ibi can be further subdivided into two levels or three levels to be controlled, but a case where the bias current Ibi and the peak current Ipe are single levels, respectively will be explained here for simplicity of explanation.

When an ordinary recording pulse is generated, the LD driving circuit 29 first produces bias current Ibi set to a level slightly higher than the threshold current Ith where the semiconductor laser 20 starts laser oscillation (namely, emission light intensity starts to increase rapidly) to drive the semiconductor laser 20, as shown in FIG. 4A. Thereafter, peak current Ipe for obtaining the desired recording power is applied at time A, and after the peak current Ipe is applied for a period, the laser driving current is raised to the bias current Ibi at time B again. Change of emission light intensity of the semiconductor laser 20 according to time is shown in FIG. 4B.

As shown in FIG. 4B, emission light intensity is maintained at a considerably low power which cannot conduct recording on the optical disk 1 by the time A by which the semiconductor laser 20 is driven by the bias current Ibi, but the emission light intensity is raised up to the recording power along with application of the peak current Ipe to the semiconductor laser 20 and the raised level is maintained until the driving current is lowered to the bias level Ibi at the time B. The emission light intensity lowers to a lower power again after the time B. Thus, the semiconductor laser 20 is controlled such that ordinary recording pulses are emitted for a period from the time A to the time B.

If the emission light intensity is observed more carefully, such an aspect is observed that, when the emission light intensity is raised up to the recording power at the time A, the emission light intensity instantaneously rises and lowers before the emission light intensity is stabilized at a steady state (a broken line circle portion in FIG. 4B). This phenomenon is relaxation oscillation of the emission light intensity occurring in the semiconductor laser 20. In production of ordinary recording pulses, control is performed such that the relaxation oscillation is made as small as possible.

The relaxation oscillation is a transitional oscillation phenomenon occurring when the laser driving current rises rapidly from a certain level to a fixed level largely exceeding the threshold current Ith. The relaxation oscillation gradually becomes small according to repetition of oscillation so that the oscillation is converged finally.

In the optical recording apparatus according to the embodiment, the relaxation oscillation is positively utilized for recording. Specifically, a leading one of relaxation oscillation pulses obtained by the relaxation oscillation is used as a short optical recording pulse. In this case, as shown in FIG. 4C, the LD driving circuit 29 first produces the bias current Ibi set to a level lower than the threshold current Ith of the semiconductor laser 20 to drive the semiconductor laser 20.

Thereafter, the LD driving circuit 29 raises the laser driving current up to the peak current Ipe rapidly at the time A with a rising time faster than production of ordinary recording pulses and after a time elapsing shorter than the production of the ordinary recording pulses, the LD driving circuit 29 lowers the peak current Ipe to the bias current Ibi at the time C again. Change of the emission light intensity of the semiconductor laser 20 according to time elapsing is shown in FIG. 4D.

As shown in FIG. 4D, the semiconductor laser 20 does not start laser oscillation by the time A by which the semiconductor laser 20 is driven by the bias current Ibi lower than the threshold current Ith, where light emission with a negligible level as the light emitting diode only occurs. Thereafter, the relaxation oscillation starts according to rapid increase of the application current at the time A so that emission light intensity increases rapidly. Then, light emission based upon the relaxation oscillation is maintained until the time C at which the application current is brought back to the threshold current or less again. In this example, the time C is reached at a timing at which the second cycle pulses of the relaxation oscillation have been generated, where production of the recording pulses is terminated.

Thus, the short optical recording pulse generated by the relaxation oscillation has such a feature that emission light intensity rises in a very short time and the emission light intensity lowers with a constant period determined according to the structure of the semiconductor laser, which is different from the ordinary recording pulse. Accordingly, by using pulses obtained by the relaxation oscillation as recording pulses, it is possible to obtain short optical recording pulses having short rising and short falling times and having strong peak intensity, which cannot be obtained by ordinary recording pulses.

As a generally known relationship, there is the following relationship between the laser resonator length L and the relaxation oscillation period T of the semiconductor laser.

T=k×{2 nL/c} (1)

Here, k represents a constant, n represents the refraction index of the active layer of the semiconductor laser, and C represents the light speed (3.0×10⁸ m/s). Therefore, it is understood that the LD resonator length L and the relaxation oscillation period T, and, therefore, the relaxation oscillation pulse width are in a proportional relation.

From the above, when the relaxation oscillation pulse width should be elongated, the laser resonator length L can be extended, and when the relaxation oscillation pulse width should be reduced, the laser resonator length L can be shortened. That is, it is said that the relaxation oscillation pulse width can be controlled by the laser resonator length L.

FIG. 5 shows a measurement result of a relaxation oscillation waveform of emission light intensity obtained when the laser resonator length L of the semiconductor laser 20 is 650 μm. It is found that the relaxation oscillation pulse width is a full width at half maximum, which is about 81 ps. Since it is understood from the above Equation (1) that the laser resonator length L and the relaxation oscillation pulse width are in a proportional relation, the following relationship is obtained as a conversion equation of the laser resonator length L and relaxation oscillation pulse width (FWHM) Wr obtained.

Wr (ps)=L (μm)/8.0 (μm/ps) (2)

Next, recording of data to an optical recording medium in the optical recording apparatus according to the embodiment will be described. The optical disk 1 is a rewritable type disk, for example, DVD-RAM, DVD-RW, HDDDVD-RW, or HDDVD-RAM, and a recording layer thereof is formed from a phase-change material. In the phase-change type optical disk, recording and erasing of data bits are performed by controlling the intensity of pulse-like laser light focused on the recording layer.

The “recording” is a process of forming an amorphous mark on a region which is initialized into a crystallization state for the recording layer. The amorphous mark is formed by melting phase-change material and rapidly cooling the same just after melted. Therefore, it is necessary to focus pulse-like laser light having relatively short duration and high power on the phase-change recording layer to raise a local temperature up to a temperature exceeding a melting point Tm of the phase-change material and cause local melting. Thereafter, when the recording pulses are stopped, the melted local region is cooled rapidly so that a solid amorphous mark is formed via a melting-rapid cooling process.

On the other hand, erasing of recorded data bits is performed by recrystallizing the amorphous mark. The crystallization is realized by local annealing at this time. By focusing laser light on the recording layer and performing control to a level slightly lower than the recording power, the local temperature of the phase-change recording layer is raised up to a crystallization temperature Tg or higher and maintained at a temperature lower than the melting point Tm.

By maintaining the local temperature between the crystallization temperature Tg and the melting point Tm for a certain period, the amorphous mark can be phase-changed to a crystallized state. Thus, erasing of the recording mark can be made possible.

Incidentally, the time in which the temperature is maintained between the crystallization temperature Tg and the melting point Tm required for crystallization is called “crystallization time”. DC laser light of a lower power such that the recording layer is not phase-changed, namely, a reproducing power, is irradiated on the information recording layer for reproduction of data bits recorded.

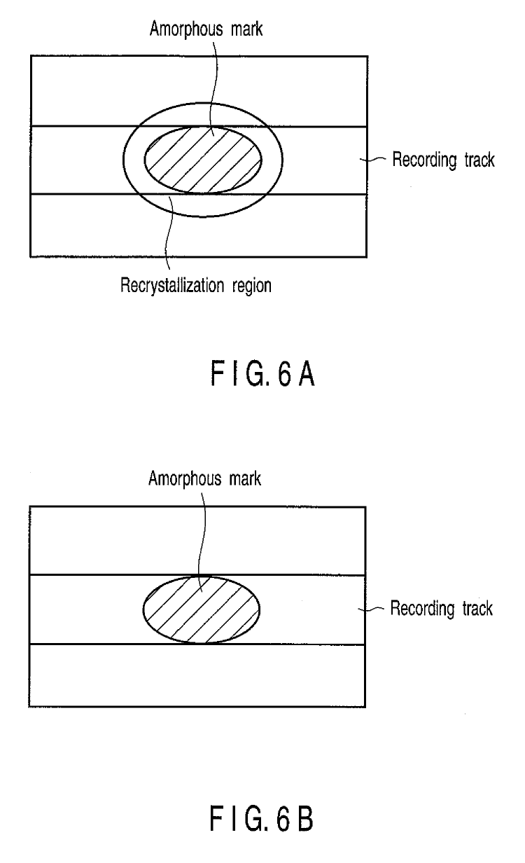

The optical recording apparatus according to the embodiment has such a feature that short optical recording pulses obtained by the relaxation oscillation are used as recording pulses used for recording of data bits. When the amorphous mark formed by the ordinary recording pulses is formed via the melting-rapid cooling process of a phase-change material, as described above, an annular region due to recrystallization (recrystallized ring) occurs on a peripheral edge portion of the amorphous mark, as shown in FIG. 6A.

The annular region is formed by recrystallization of a melted region around the peripheral edge portion of the amorphous mark because the melted region is put in a temperature region between the crystallization temperature Tg and the melting point Tm for a crystallization time or longer in a cooling process. The annular region has such an effect (self-sharpening effect) that it eventually reduces a size of the amorphous mark, but it may cause jitter (fluctuation) of reproduction signals at a mark peripheral portion, thermal interference between the previous and next marks on a track, or partial erase (cross erase) of a mark formed on an adjacent track.

On the other hand, an amorphous mark formed by short optical recording pulses obtained by the relaxation oscillation in the same manner as the optical recording apparatus according to the embodiment does not form a recrystallization ring on a peripheral edge portion of an amorphous mark as shown in FIG. 6B. This is because irradiation of laser light of high power as short optical recording pulses is performed for a short period of time so that the phase-change layer is melted just after the laser light irradiation, and the irradiation is terminated before a melted region significantly spreads to a peripheral edge portion due to thermal transfer, so that only a melted portion just after laser light irradiation is formed into an amorphous mark.

Thus, the amorphous mark which does not generate a recrystallized ring due to utilization of short optical recording pulses has such a merit that occurrence of jitter at the mark peripheral edge portion is reduced, or mark deformation or edge shift due to thermal interference between previous and next marks on a track, or cross erase of a mark formed on an adjacent track does not occur.

Of course, recording utilizing short optical recording pulses has such a merit that a record mark such as described above is improved qualitatively, and it goes without saying that the recording also has such a merit that it is suitable for high transfer rate recording, since a mark can be recorded in a short period of time.

The optical disk is strongly requested to have a high transfer rate in addition to a demand for a large capacity. Regarding HDDVD-R or HDDVD-RW, the 2× speed standard has already been put into force, based on a 1× speed (linear speed: 6.61 m/s). Higher speeds, such as 4× speed or 8× speed, are expected to be desired in the future.

In order to achieve a high transfer rate, it is necessary to record a record mark at high speed, namely, in a short period of time. Regarding a phase-change type disk, this means recording an amorphous mark utilizing short optical recording pulses. For example, in the HDDVD scheme, if an 8× speed is adopted, a channel clock rate is 518.4 Mbps and a time corresponding to one channel bit is 1.929 ns.

The pulse width required for the short optical recording pulse in the optical recording apparatus according to the embodiment is such a pulse width that a recrystallization ring does not form at a forming time of an amorphous mark. A region on which a recrystallization ring is formed at a forming time of an amorphous mark is a region around an amorphous mark peripheral edge portion once melted as described above, namely, a region whose temperature exceeds a melting point of a phase-change material. At this time, only a region whose temperature slightly exceeds the melting point is recrystallized.

This is because a region whose temperature is raised up to a temperature largely exceeding a melting point is changed to an amorphous state since it has a large gradient where the temperature lowers and it is cooled relatively rapidly. As understood from a known relationship (Furrier thermal conduction rule): q=K·δT/δx between a temperature gradient δT/δx and a heat flow density q(W/m²), this is because a heat flow from a high temperature region to a low temperature region becomes larger according to the increase of the temperature gradient. Here, K(W/m·K) represents heat conductivity, and x represents a distance on an interface having a temperature difference in a direction of heat transfer (a normal vector direction on an interface).

In the case of recording conducted by using short optical recording pulses, laser light with high power is irradiated such that a temperature of a light spot central portion exceeds a melting point just after laser light irradiation.

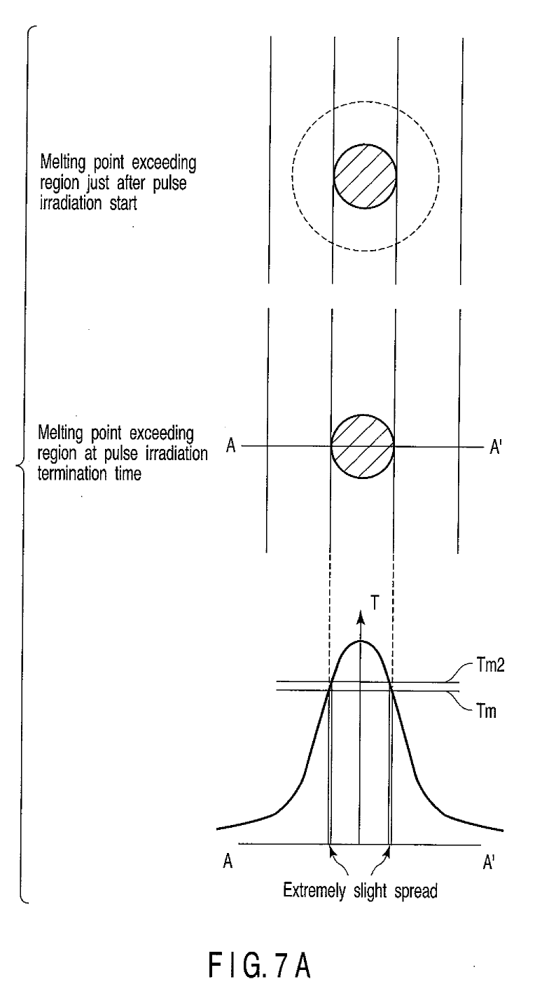

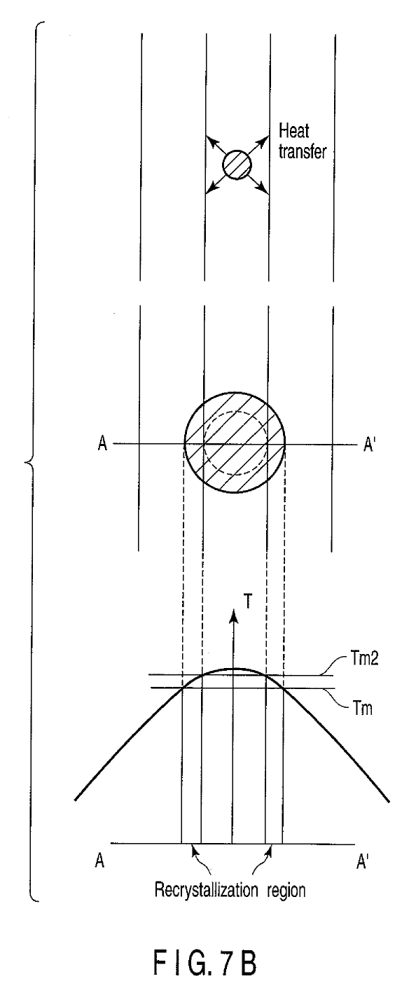

FIG. 7A shows a temperature distribution on a recording track when recording is performed by using short optical recording pulses, and FIG. 7B shows a temperature distribution on a recording track when recording is performed by using ordinary recording pulses. In FIGS. 7A and 7B, an upper stage shows a melting point-exceeding region on a track just after recording pulse irradiation, a middle stage shows a melting point-exceeding region just at a time of recording pulse termination, and a lower stage represents a temperature distribution in section A-A′ on the middle stage. Incidentally, a recording beam spot (a region represented by a broken line in FIG. 7A) originally moves in up and down directions during pulse radiation, but it does not move in this example, for simplicity of explanation.

In each case of recording using the short optical recording pulse and recording using an ordinary recording pulse, a region whose temperature exceeds the melting point at a light spot middle expands due to heat transfer for a period of time from just after pulse irradiation to termination of pulse radiation. However, in the case of using the short optical recording pulses, since a pulse irradiation time is short, expansion hardly occurs.

In the case of recording using the short optical recording pulses, a temperature distribution in a section including a light spot middle at a termination time of pulse irradiation takes a Gaussian distribution shape approximately equal to a distribution just after light beam irradiation, where a rapid temperature gradient occurs in a boundary region between above and below the melting point. Therefore, a region to be recrystallized, namely, a region in a range where a temperature slightly exceeds the melting point (a region having a temperature between a melting point Tm and a temperature Tm2 in FIG. 7A) hardly spreads in a plane direction. Accordingly, if the light intensity (laser power) becomes zero in such a short period of time that expansion of a region having a melting point or higher at the light spot middle due to head transfer is negligible, occurrence of a recrystallization ring is limited to a very small region.

On the other hand, in the case of mark formation utilizing ordinary recording pulses, since laser light of relatively low power is irradiated for a long period of time, a region whose temperature exceeds the melting point at the light spot middle gradually expands (from an upper stage to a middle stage in FIG. 7B). At this time, a temperature distribution in a section including the light spot middle is no longer a Gaussian distribution but takes a shape having a gentle temperature gradient (a lower stage in FIG. 7B).

Therefore, a recrystallizing region has a relatively large spread in a plane direction. A broken line in the middle stage in FIG. 7B shows a recrystallization limit, and an inner region of the broken line is a region forming an amorphous mark. Thus, the ordinary recording pulse eventually forms a large recrystallization ring at a mark forming time.

It is thought that the width of the recrystallization ring in the plane direction is approximately equal to a diffusion distance of a melting point region in a plane direction at a pulse radiation period of time. Assuming a common phase-change material having the heat conductivity K=0.005 J/cm/s/° C. and the specific heat C=1.5 J/cm³/° C., a heat diffusion distance within a pulse radiation period of time can be estimated. Since it is thought that heat diffuses by a distance L=(Kt/C)^{1/2} at the time t, a region of a recrystallization ring is limited to a range of at most 10% of the shortest mark length 0.204 μm for HDDVD-RW. That is, since there is a limitation to a range of 10.2 nm or less in one direction, the pulse irradiation period of time is 0.44 ns. This time may be the pulse width required for the short optical recording pulse.

As described above, since the Equation (2) can be obtained as the relationship between the laser resonator length L of the semiconductor laser and the relaxation oscillation pulse width Wr obtained, it is understood that it is necessary to use the pulse width of 440 ps or less, namely, the semiconductor laser with a resonator length of 3520 μm or less for recording using the short optical recording pulse.

On the other hand, it is better to make the pulse irradiation period of time shorter in order to reduce the recrystallization ring, but in practice it is difficult to provide the energy for raising the temperature of the phase change material up to a melting point thereof. That is, it is necessary to irradiate laser light of an extremely high power in a short period of time. Therefore, it can be thought that the pulse irradiation period of time should be about 50 ps or more in practice. Such a fact means that a semiconductor laser with a laser resonator length of 400 μm or longer is required, in view of the relationship of the Equation (2).

As is understood from the Equation (2), when relaxation oscillation pulses are used for information recording on an optical disk 1, a relaxation oscillation pulse width is determined uniquely according to determination of the laser resonator length of the semiconductor laser 20 used in the optical recording apparatus. As described above, when the pulse width is short, the phase-change material is raised up to the melting point or higher by irradiation of laser light of high power, but such a case may occur that the temperature of the phase-change material does not reach the melting point or higher even if irradiation of laser light is performed at maximum power. In such a case, it is effective to conduct irradiation of relaxation oscillation pulses of laser light plural times.

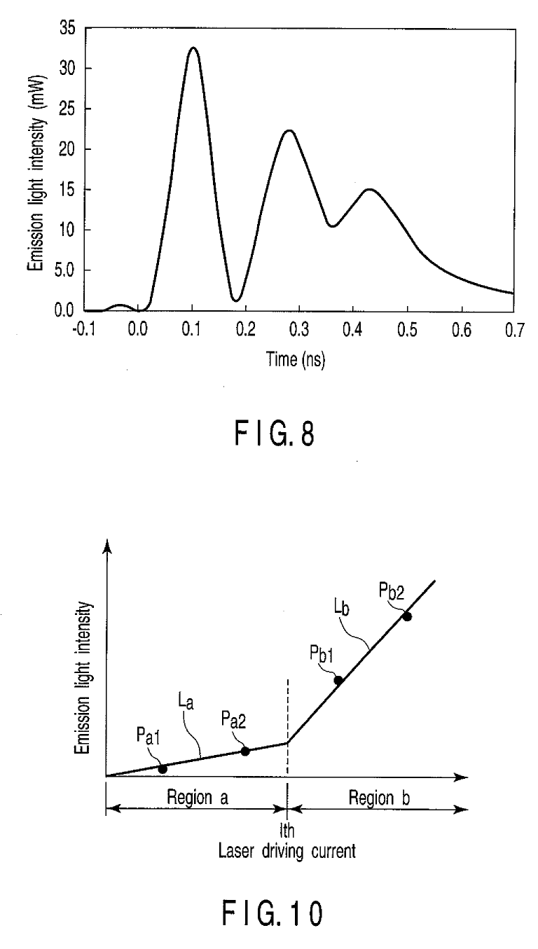

FIG. 8 shows a relaxation oscillation waveform of emission light intensity obtained when the laser driving current to the semiconductor laser 20 is controlled such that the semiconductor laser 20 generates the relaxation oscillation pulse three times. The irradiation energy obtained by the pulses (a time integration value obtained by pulses in FIG. 8) is increased by generating a relaxation oscillation pulse three times so that the temperature of the phase-change material can be raised up to the melting point or higher. However, as is understood from FIG. 8, pulse intensities of the second and third pluses gradually decrease as compared with the first relaxation oscillation pulse. Therefore, irradiation of pulses more than three times is not so effective.

In the optical recording apparatus which records data on the optical recording medium using relaxation oscillation pulses of the semiconductor laser 20 in this manner, it is necessary to increase or decrease the number of relaxation oscillation pulses according to the laser resonator length. Even when a semiconductor laser with a low rated output is used, it is effective to use a relaxation oscillation pulse plural times.

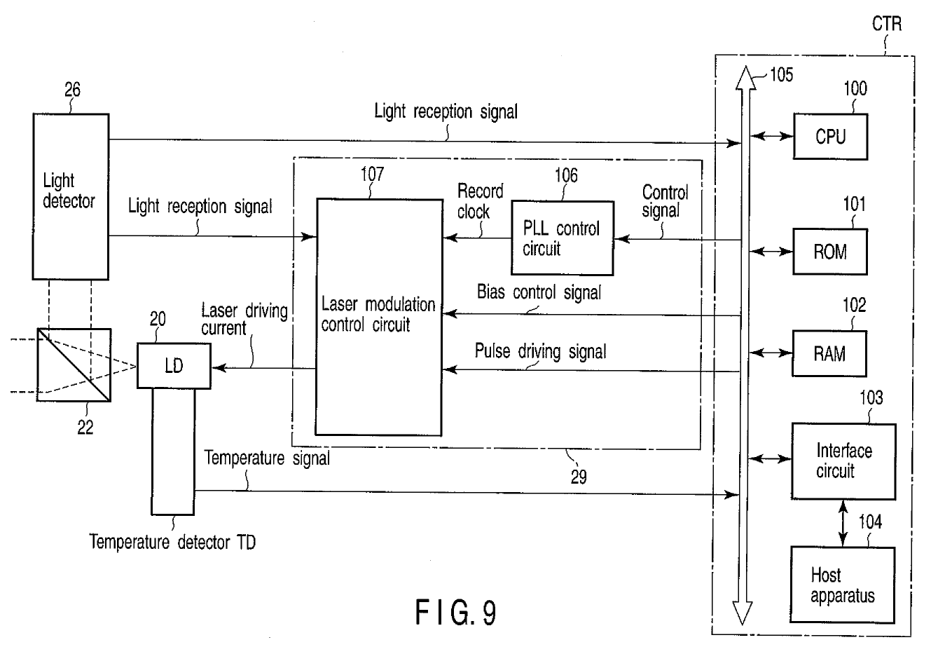

FIG. 9 shows the semiconductor laser drive control structure of the optical recording apparatus shown in FIG. 1 in more detail.

In the semiconductor laser drive control structure, a PLL control circuit 106 and a laser modulation control circuit 107 are provided as the semiconductor laser driving circuit (LD driving circuit) 29, and a CPU 100, a ROM 101, a RAM 102, an interface 103, and a host apparatus 104 are provided as the controller CTR. In the controller CTR, the CPU 100, the ROM 101, the RAM 102, and the interface 103 are mutually connected via a bus 105, and the host apparatus 104 is connected to the interface circuit. The CPU 100 conducts various types of data processing required for recording and reproduction of data. The ROM 101 stores a control program for the CPU 100 and various fixed data items therein, and the RAM 102 stores input and output data items for the CPU 100 therein temporarily. The interface circuit 105 receives record data supplied from the host apparatus 104. The record data is converted into the DVD record format in the controller CTR to be supplied to a laser modulation control circuit 107 as a pulse driving signal. A PLL control circuit 106 outputs a record clock to the laser modulation control circuit 107 at a data recording time. The laser modulation control circuit 107 applies the laser driving current corresponding to a pulse driving signal to the semiconductor laser 20 in synchronism with the record clock at the data recording time. A bias control signal from the controller CTR is used to set bias current Ibi to the laser driving current in the laser modulation control circuit 107. A temperature detector TD measures a temperature T of the semiconductor laser 20 to supply temperature data which is the measurement result to the controller CTR. Part of the laser light emitted from the semiconductor laser 20 is branched by a half mirror of the polarization beam splitter 22 at a fixed ratio to enter the light detector 26. The light detector 26 is a photo diode which detects the emission light intensity of the semiconductor laser 20 to output a light reception signal proportional to the emission light intensity. The light reception signal is fed back to the laser modulation control circuit 107 to control the laser driving current so that the emission light intensity of the semiconductor laser 20 having a proper relationship with the laser driving current can be obtained at a recording time.

The LD driving circuit 29 is configured to apply pulses transiting from the bias current Ibi to the peak current Ipe as a laser driving current which relaxation-oscillates emission light intensity of the semiconductor laser 20, thereby driving the semiconductor laser 10. In this case, it is important to limit fluctuation of a leading (first) peak value of emission light intensity occurring for each pulse application in order to conduct information recording with high record quality using laser light with an emission light waveform accompanying relaxation oscillation. The fluctuation of the leading peak value depends on the bias current Ibi. Even if the threshold current of the semiconductor laser 20 fluctuates, a ratio of the bias current Ibi to the threshold current of the semiconductor laser 20 is maintained.

That is, the light reception signal from the light detector 26 is also supplied to the controller CTR to be utilized to acquire a temperature characteristic of the semiconductor laser 20 regarding emission light intensity in a manufacturing stage. A control circuit comprising the temperature detector TD and the controller CTR controls the bias current Ibi such that the bias current Ibi has a predetermined ratio limiting fluctuation of the leading peak value of the relaxation oscillation occurring for each pulse application, mentioned above, relative to the threshold current of the semiconductor laser 20. Further, the controller CTR changes the bias current Ibi so as to maintain the predetermined ratio relative to fluctuation of the threshold current. The predetermined ratio is a percentage in a range of 70% to less than 100%. The CPU 100, the ROM 101, and the RAM 102 configure a processing unit which conducts an estimating processing for estimating the threshold current Ith of the semiconductor laser 20 relative to a temperature T measured by the temperature detector TD. In the processing unit, a relational table between the temperature T of the semiconductor laser 20 and the threshold current Ith of the semiconductor laser 20 is held in the RAM 102 as an intrinsic parameter of the semiconductor laser 20 in advance, where an estimating processing is performed based upon the relational table. Incidentally, the processing unit may be configured such that a function approximating a relationship between the temperature T of the semiconductor laser 20 and the threshold current Ith of the semiconductor laser 20 is held in the RAM 102 as an intrinsic parameter of the semiconductor laser 20 in advance, and the estimating processing is performed based upon such function.

The abovementioned semiconductor laser drive control structure is determined based upon the following principle.

FIG. 10 shows a relationship between the laser driving current and emission light intensity. Referring to FIG. 10, there is a boundary value from which the emission light intensity increases rapidly to the laser driving current. The boundary value is the threshold current Ith of the semiconductor laser 20. In FIG. 10, Pₐ₁ and Pₐ₂ are measured values of emission light intensity obtained at two coordinate points included in a region “a” of the laser driving current that is smaller than the threshold current Ith, and P_{b1} and P_{b2} are eventually measured values of emission light intensity obtained at two coordinate points included in a region “b” of the laser driving current, which is larger than the threshold current Ith. Lₐ and L_{b} are straight lines of linear functions which can be obtained from these measured values. The straight lines Lₐ and L_{b} of the linear functions approximate relationships between the laser driving current and the emission light intensity in the regions “a” and “b”, respectively, and it is estimated that the threshold current Ith is a current value at an intersecting point of these straight lines Lₐ and L_{b}.

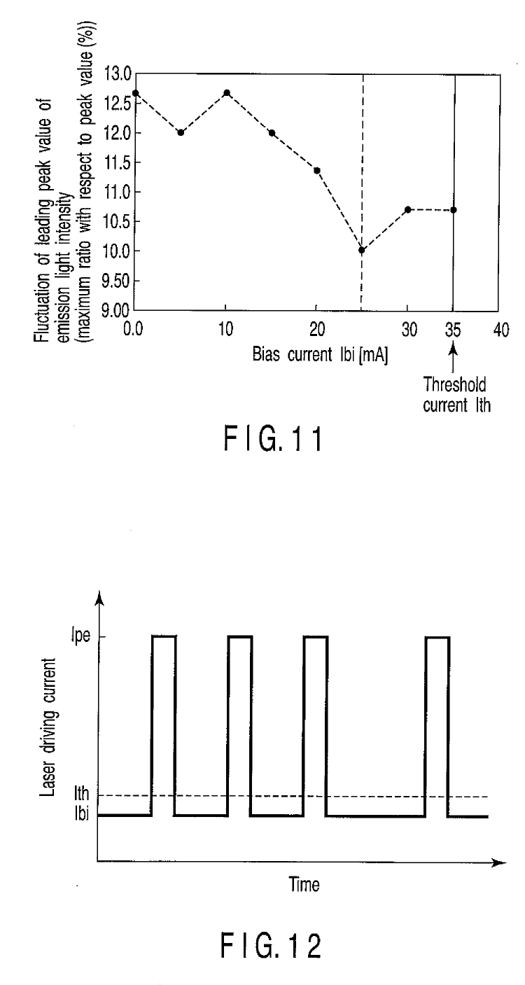

FIG. 11 shows a relationship between the bias current Ibi and fluctuation of the leading peak value of emission light intensity obtained by the relaxation oscillation. The leading peak value is one amplitude of a leading one of the relaxation oscillation pulses used as the short optical record pulse. Referring to FIG. 10, the fluctuation of the leading peak value is relatively small in a range of the bias current Ibi from 25 mA to the threshold current Ith (=35 mA). Going by the threshold current Ith (=35 mA), the bias current Ibi=25 mA approximately corresponds to 70% of the threshold current Ith. Therefore, the predetermined ratio is determined to be in a range from 70% to less than 100%, and control is made such that the bias current Ibi has such a predetermined ratio to the threshold current Ith of the semiconductor laser 20. However, the threshold current Ith of the semiconductor laser 20 generally increases according to the temperature rise of the semiconductor laser 20, which makes the bias current Ibi inadequate. Therefore, when the threshold current Ith that is fluctuated due to change of the temperature T of the semiconductor laser 20 is estimated and the bias current Ibi shown in FIG. 12 is controlled so as to have a percentage in the range from 70% to less than 100% to the threshold current Ith, the problem of fluctuation of the threshold current Ith can be overcome.

That is, the relationship between the temperature T of the semiconductor laser 20 and the threshold current Ith of the semiconductor laser 20 is obtained from such a viewpoint mentioned above in advance, and is held as the relational table. By measuring the temperature T of the semiconductor laser 20 at a usage time of the apparatus and changing the bias current Ibi so as to maintain the predetermined ratio to the threshold current Ith estimated from the measured temperature T using such a relational table, the relaxation oscillation waveform of emission light intensity can be stabilized to limit the fluctuation of the leading peak value even if fluctuation of the threshold current Ith depending on the temperature T of the semiconductor laser 20 occurs.

A procedure for obtaining the threshold current Ith of the semiconductor laser 20 will be explained below. The threshold current Ith can be predicted from the specification of the semiconductor laser 20, but it is not accurate. In view of these circumstances, it is difficult to section the laser driving current into the regions “a” and “b” as shown in FIG. 10. Accordingly, regarding the regions “a” and “b”, it is necessary to change the laser driving current by a fixed increment to confirm the change in emission light intensity relative to the increment, thereby obtaining the threshold current Ith.

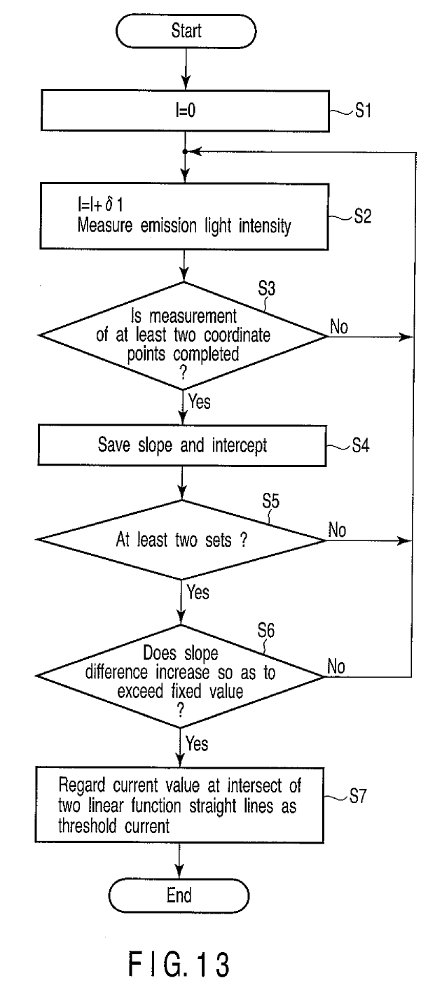

FIG. 13 shows one example of a processing for obtaining the threshold current Ith. In the processing, a laser driving current is set to 0 at the first step S1. The emission light intensity of the semiconductor laser 20 obtained by driving the semiconductor laser 20 with the laser driving current added with such an increment as, for example, 5 mA is measured, and a combination of the laser driving current and the emission light intensity is saved in the RAM 102 at the next step S2. Whether or not measurement of at least two coordinate points has been completed is checked at step S3. When the measurement at step S2 has not been completed, the processing at steps S2 and S3 is performed again. When the measurement at step S2 has been completed, values of a slope and an intercept of a straight line of a linear function approximating the relationship between the laser driving current and the emission light intensity are obtained using all the combinations of the measurement results, and are saved in the RAM 102 at step S4. Whether or not the number of combinations of the slope and the intercept of the straight line of the linear function saved in the RAM 102 is at least two is checked at the next step S5. When the number of combinations is less than two, the processing at steps S2 to S5 is performed again. When the number of combinations is at least two, whether or not a difference between the slope of the straight line of the linear function saved previously and the slope of the straight line of the linear function saved next increases to exceed a fixed value is checked at step S6. When the difference does not exceed the fixed value, the processing at steps S2 to S5 is performed again. When the difference exceeds the fixed value at step 6, it is determined at step S7 that a current value at the two intersecting points of the straight lines of the linear functions are the threshold current Ith of the semiconductor laser 20. The threshold current Ith of the semiconductor laser 20 can be obtained according to the determination processing as described above. However, it is not absolutely required to obtain the threshold current Ith of the semiconductor laser 20 according to such a procedure as shown in FIG. 13, and the threshold current Ith of the semiconductor laser 20 can be obtained by another method. For example, such a method can be adopted that the minimum threshold value of emission light intensity regarding the relationship between the laser driving current and the emission light intensity or the like is provided and measurement regarding only the region “b” exceeding the minimum threshold is performed to obtain the straight line of the linear function so that a current value of an intercept of the straight line of the linear function to a coordinate axis of the laser driving current is regarded as the threshold current Ith approximately.

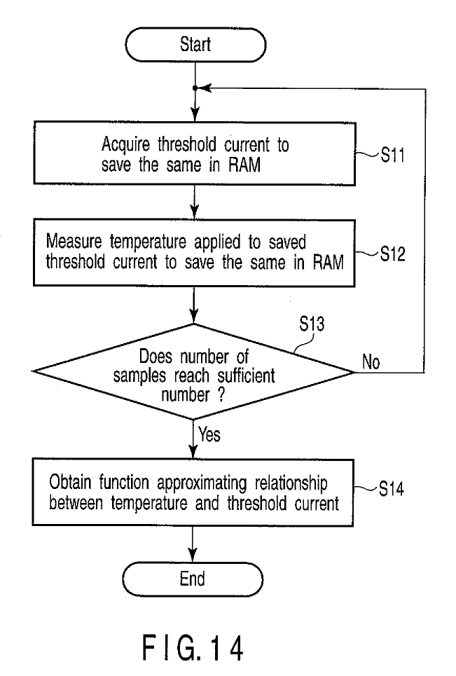

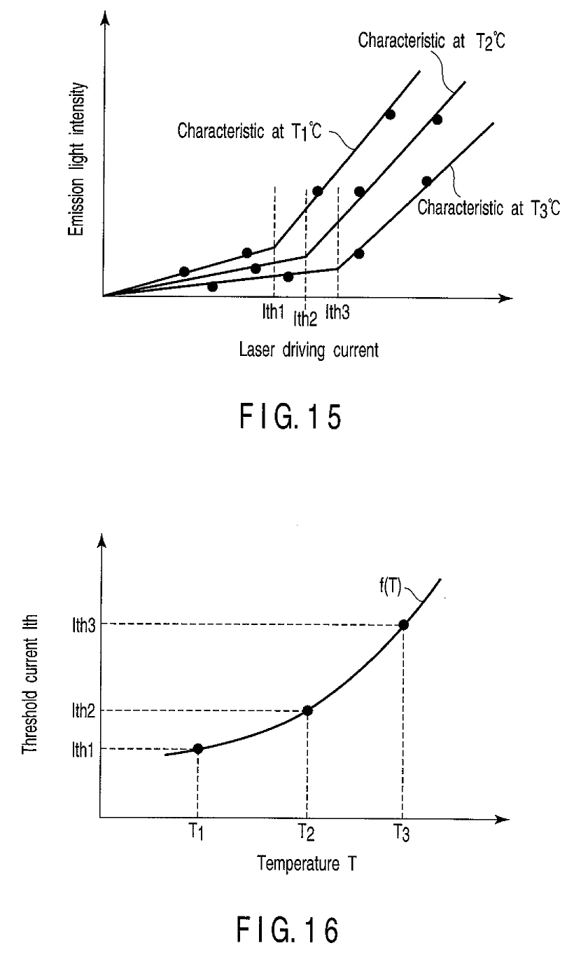

In a manufacturing stage prior to use of the apparatus, the threshold current Ith is obtained in the above manner and the relationship between the temperature T of the semiconductor laser 20 and the threshold current Ith is also obtained. FIG. 14 shows one example of a processing for obtaining the relationship between the temperature T of the semiconductor laser 20 and the threshold current Ith. In this processing, the threshold current Ith is acquired at the processing shown in FIG. 13 to be saved in the RAM 102 at step S11, the temperature T applied to the threshold current Ith is measured to be saved in the RAM 102 in combination with the threshold current Ith at step 12, and whether or not the number of samples of the combination of the temperature T and the threshold current Ith reaches a sufficient number is checked at step S13. If the number of samples is insufficient, the processing at steps S11 to S13 is repeated. When the number of samples is sufficient, the processing step S14 is performed. When the temperature T of the semiconductor laser 20 is changed to T₁, T₂, and T₃, three characteristics of the laser driving current-emission light intensity can be obtained at T₁, T₂, and T₃, respectively, as shown in FIG. 15. In this case, the threshold current Ith is changed to Ith1, Ith2, and Ith3 to T₁, T₂, and T₃, respectively. The function f(T) approximating the relationship between the temperature T of the semiconductor laser 20 and the threshold current Ith such as shown in FIG. 16, or the relational table between the temperature T of the semiconductor laser 20 and the threshold current Ith is prepared from the combinations of T₁, T₂, and T₃ and Ith1, Ith2, and Ith3, and is saved in the RAM 102 at step S14. The function f(T) is a high-degree polynomial regarding the temperature T, for example, and the degree is determined according to cost of measurement or estimation precision of the threshold current value required. Regarding the function f(T), a coefficient representing its characteristics and the like can be saved in the RAM 102.

By conducting an operation of the function f(T) based upon the temperature T measured by the temperature detector TD and the abovementioned coefficient saved in RAM 102 or referring to the relational table at the use time of the apparatus, the threshold current Ith corresponding to the measured temperature T is obtained, the threshold current Ith fluctuated by the temperature T of the semiconductor laser 20 is estimated, and the bias current Ibi shown in FIG. 12 is controlled so as to have a percentage in a range of 70% to less than 100% to the threshold current Ith.

In the embodiment, control is made such that the bias current Ibi has a predetermined ratio limiting fluctuation of the leading peak value relative to the threshold current Ith of the semiconductor laser. In the control, when the threshold current Ith of the semiconductor laser fluctuates depending on the temperature T, it becomes impossible to limit the fluctuation of the leading peak value reliably, so that the bias current Ibs is changed to maintain the predetermined ratio relative to the fluctuation of the threshold current. Accordingly, even if the threshold current Ith fluctuates, the relaxation oscillation waveform of emission light intensity can be stabilized. When the above control is performed, a thermoelectric cooler (TEC) such as a Peltier element can be omitted because it is unnecessary to prevent temperature change of the semiconductor laser 20.

Incidentally, the present invention is not limited to the embodiment as it is, and may be embodied in its implementing stage by modifying constituent elements without deviating from the gist of the present invention. For example, in the abovementioned embodiment, the rewritable type optical disk using the phase-change material is used as an example, but the present invention can also be applied to, for example, a write-once (recordable) optical disk.

Various inventions can be configured by proper combinations of a plurality of constituent elements disclosed in the embodiment. For example, some constituent elements may be omitted from all the constituent elements disclosed in the embodiment. A combination with constituent elements of another embodiment can be adopted, accordingly.

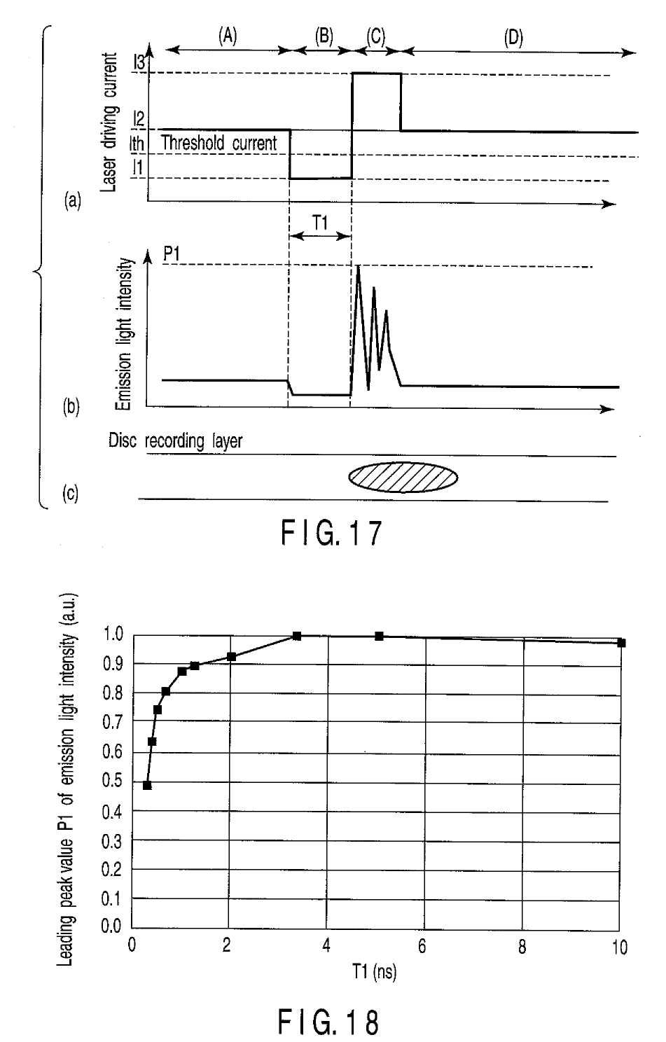

Further, the present invention can be applied to a bias current Ibi of the laser driving current applied to the semiconductor laser 20 with a waveform such as shown in FIG. 17. In FIG. 17, (a), (b), and (c) show a time region of the laser driving current supplied from the LD driving circuit 29 to the semiconductor laser 20, a waveform of emission light intensity of the semiconductor laser 20, and a mark (record mark) formed on a recording film on the optical disk 1 by emission light (laser light) from the semiconductor laser 20, respectively.

In (a) in FIG. 17, the emission light intensity of the semiconductor laser 20 is controlled to be at a reproduction power, which is used when information is regenerated from the optical disk 1 in the region (A) positioned on a place where a light-focusing point on the recording film of the optical disk 1 does not form a record mark in order to read position information on the optical disk 1 and cause a servo to act. That is, the laser driving current with a magnitude I2, which is larger than the threshold current Ith which is the laser driving current which can conduct laser oscillation, is supplied to the semiconductor laser 20.

In the region (C), the laser driving current (=peak current) I3, which is further larger than I2, is supplied to the semiconductor laser 20, and laser light is emitted as a relaxation oscillation pulse reaching the maximum leading peak value P1 such as shown in (b) in FIG. 17.

Incidentally, the laser driving current (=bias current) I1, which is smaller than the threshold current Ith, is supplied to the semiconductor laser 20 for a predetermined period of time T1 just before the region (C) where the relaxation oscillation pulse is output, namely, for the region (B).

The magnitude of the laser driving current after the relaxation oscillation termination, namely, in the region (D), is changed back to the abovementioned I2, which is larger than the threshold current Ith.

That is, in the present invention which uses laser light which is a sharp pulse obtained by the relaxation oscillation to record information on the optical disk 1, the time-average power of laser light emitted at a recording time is smaller than the laser power (reproduction power) required to reproduce information recorded on the optical disk 1, and when recording is started just after information has been regenerated from the optical disk 1, the average laser power emitted from the laser is fluctuated.

According to fluctuation of the average laser power, the temperature of the semiconductor laser 20 changes so that the threshold current Ith of the semiconductor laser 20 also fluctuates.

The fluctuation of the threshold current Ith changes the emission light intensity before and after the temperature change even when the semiconductor laser 20 is driven by the same laser driving current. Thereby, change of the threshold current Ith is not desirable in order to record an excellent mark on a recording film on the optical disk 1.

In order to avoid such a problem, it is desirable that average powers of emission light at a reproduction time and at a record time are made approximately equal. Incidentally, regarding the average powers of emission light at the reproduction time and at the record time, it has been confirmed that, for example, when a first average power (A) used at a reproduction time and a second average power (B) are in a range of 0.8<A/B<1.2, influence of temperature change is generally negligible.

FIG. 18 shows a relationship between a period of time T1 setting the current value of a drive time supplied to the semiconductor laser 20 to I1 and the leading peak value P1 of emission light intensity of the relaxation oscillation. The semiconductor laser 20 transits the laser driving current from 20 mA to 120 mA at a rising time of 150 ps rapidly with a wavelength 405 nm, a resonator length of 800 μm, and threshold current of laser oscillation of 35 mA.

As explained above, since the relaxation oscillation is a transitional oscillation phenomenon which occurs when the laser driving current rapidly rises from a level to a fixed level largely exceeding the threshold current Ith, it is essential that the pulse width (recording pulse length) is stable in order to utilize the relaxation oscillation as the record pulse. Incidentally, when the period of time T1 is small, it has been confirmed that the maximum power P1 of laser occurring due to the relaxation oscillation is small and the maximum power P1 becomes larger up to about 2.2 times a steady oscillation power according to prolonging of the period of time T1. Thereafter, the maximum power P1 converges but the laser intensity after the relaxation oscillation converges is set to 0.45×P1 in this system. When the leading peak value P1 of the relaxation oscillation is large, it has been found that the total recording energy becomes smaller than the recording energy upon the steady power oscillation. In the optical disk on which a record mark is recorded by thermal recording (thermal energy amount supplied as laser light), a heat diffusion time is about 1 ns as compared with a case that a mark is recorded by laser irradiation with an ordinary lower power for a long period of time, so that heat is diffused even during laser irradiation in the ordinary recording waveform conducting recording for a period of time longer than 1 ns. On the other hand, since high power irradiation is conducted in a short period of time of 1 ns or shorter using relaxation oscillation, diffusion of heat during laser irradiation is small. Therefore, the recording method using relaxation oscillation is smaller than the ordinary recording method exceeding 1 ns regarding the recording energy obtained by integrating the power over the irradiation period of time. When the leading peak value P1 of the relaxation oscillation reaches 2.2 times the ordinary steady laser intensity like the above, the recording energy lowers to about 40% of the ordinary steady oscillation laser. Thereby, energy consumption of a pickup head becomes small, so that a temperature rise of the pickup head can be suppressed. Since such an optical element of the pickup head as an objective lens or a mirror is thermally expanded and deformed due to temperature a rise in temperature, a spot diameter collected by the objective lens becomes large so that a size of a mark to be recorded becomes large. However, when recording is conducted using relaxation oscillation, such temperature rise is suppressed, so that such a problem does not occur.

Especially, regarding the effect that the recording energy becomes small as compared with an ordinary steady laser irradiation, such an effect is found significantly when P1 is at least two times that of the steady laser. Therefore, when a mark is recorded using the relaxation oscillation, it is understood that it is desirable that a period of time of T1 where P1 is 90% of a saturated value is at least 1 ns.

Further, it has been confirmed that when T1 is at least 3 ns, the laser power becomes approximately equal to the saturated power and the period of time T1 exceeding 3 ns does not substantially influence the laser output. Therefore, it is further desirable that T1 is 3 ns or longer.

When the present invention is applied to the bias current Ibi of the laser driving current as described above, the bias current Ibi is controlled so as to have a predetermined ratio limiting fluctuation of the leading peak value relative to the threshold current Ith of the semiconductor laser. In such control, when the threshold current Ith of the semiconductor laser fluctuates depending on the temperature T, it becomes impossible to limit the fluctuation of the leading peak value reliably so that the bias current Ibi is changed so as to maintain the predetermined ratio relative to fluctuation of the threshold current. Accordingly, even if the threshold current Ith fluctuates, a relaxation oscillation waveform of emission light intensity can be stabilized. Further, when the abovementioned control is performed, it is unnecessary to prevent temperature change of the semiconductor laser 20, so that a thermoelectric cooler (TEC) such as a Peltier element can be omitted.

While certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the sprint of the inventions. The accompanying claims and their equivalents are intended to cover such forms or modifications as would fall within the scope and spirit of the inventions.

What is claimed is:

1. A drive control apparatus of a semiconductor laser comprising:
a driving module configured to drive the semiconductor laser by adjusting a laser driving current of pulses from a bias current level to a peak current level in order to cause relaxation oscillation of intensity of an emitted light of the semiconductor laser; and
a controller configured to control the bias current such that the bias current comprises a predetermined ratio between the bias current and a threshold current of the semiconductor laser for limiting fluctuation of a first peak value of the relaxation oscillation occurring for each of the pulses, the controller being configured to change the bias current to maintain the predetermined ratio in accordance with fluctuation of the threshold current.

2. The drive control apparatus of claim 1, wherein the predetermined ratio is in a range from about 70% to about 100%.

3. The drive control apparatus of claim 1, wherein the controller comprises a temperature detector configured to measure a temperature of the semiconductor laser and a processor configured to estimate the threshold current of the semiconductor laser in accordance with the temperature measured by the temperature detector.

4. The drive control apparatus of claim 3, wherein the processor is configured to estimate the threshold current based upon a relational table between the temperature of the semiconductor laser and the threshold current of the semiconductor laser stored in a memory in advance as a parameter of the semiconductor laser.

5. The drive control apparatus of claim 3, wherein the processor is configured to estimate the threshold current based upon a function approximating a relationship between the temperature of the semiconductor laser and the threshold current of the semiconductor laser stored in a memory in advance as a parameter of the semiconductor laser.

6. A drive control method of a semiconductor laser comprising:
driving the semiconductor laser by adjusting a laser driving current of pulses from a bias current level to a peak current level in order to cause relaxation oscillation of intensity of an emitted light of the semiconductor laser; and
controlling the bias current such that the bias current comprises a predetermined ratio between the bias current and a threshold current of the semiconductor laser for limiting fluctuation of a first peak value of the relaxation oscillation occurring for each of the pulses, the bias current being changed to maintain the predetermined ratio in accordance with fluctuation of the threshold current in the controlling.

7. The drive control method of claim 6, wherein the predetermined ratio is in a range from about 70% to about 100%.

8. The drive control method of claim 6, wherein the temperature of the semiconductor laser is measured and the threshold current of the semiconductor laser to the measured temperature is estimated in controlling the bias current.

9. The drive control method of claim 8, further comprising estimating the threshold current based upon a relational table between the temperature of the semiconductor laser and the threshold current of the semiconductor laser which are stored in a memory in advance as a parameter of the semiconductor laser.

10. The drive control method of claim 8, further comprising estimating the threshold current based upon a function approximating a relationship between the temperature of the semiconductor laser and the threshold current of the semiconductor laser which are stored in the memory in advance as a parameter of the semiconductor laser.
